(19) United States
(12) Patent Application Publication
(10) Pub. No.: US 2014/0368420 A1
(43) Pub. Date: Dec. 18, 2014

(54) DISPLAY APPARATUS AND METHOD FOR CONTROLLING SAME

(71) Applicant: CANON KABUSHIKI KAISHA, Tokyo (JP)

(72) Inventor: Taisuke Nishio, Kawasaki-shi (JP)

(21) Appl. No.: 14/301,013

(22) Filed: Jun. 10, 2014

(30) Foreign Application Priority Data
Jun. 14, 2013 (JP) 2013-125313

(51) Int. Cl. G09G 3/34

(52) U.S. Cl. CPC G09G 3/3406
USPC 345/102

(57) ABSTRACT

The display apparatus comprises: a light-emitting unit; a display unit; a determination unit configured to determine, for each of the plurality of light sources of the light-emitting unit, a target brightness based on a brightness of an image to be displayed in an area corresponding to the light source; a first detection unit configured to detect a first block in which a predetermined object is displayed; a second detection unit configured to detect a second block in which no moving object is displayed; a correction unit configured to correct a target brightness of a light source corresponding to a third block, which is a first block and which is a second block, on the basis of target brightnesses of surrounding light sources; and a control unit configured to control an emission brightness of each light source to the target brightness.

### BACKGROUND OF THE INVENTION

1. Field of the Invention

The present invention relates to a display apparatus and a method for controlling the same.

2. Description of the Related Art

There are known liquid crystal display apparatuses using a technique for locally reducing the emission brightness of the backlight on the basis of the brightness characteristic value of an image. With this technique, the emission brightness is reduced in areas where the image is dark, thereby suppressing the black level mis-adjustment phenomenon. On the other hand, the emission brightness of the backlight is controlled so that the display brightness is maintained in areas where the image is bright. Thus, there is obtained an effect of improving the contrast. One such technique is disclosed in Japanese Patent Application Publication No. 2002-99250, for example.

There is also a technique proposed in the art in which the emission brightness of the backlight is reduced in areas other than the area where the cursor is displayed as compared with the emission brightness of the backlight in the area where the cursor is displayed (Japanese Patent Application Publication No. 2011-13294). With this technique, there is obtained an effect of reducing the power consumption.

There is also a technique proposed in the art in which while an OSD is produced where a graphics image is superimposed on the original image, the emission brightness of the entire backlight is maintained at the brightness at the start of the OSD (Japanese Patent Application Publication No. 2005-321424). With this technique, it is possible to stabilize the display brightness of the graphics image.

However, where the emission brightness of the backlight is controlled for each area on the basis of the brightness characteristic value of the image, the display brightness may possibly change due to the superimposing display of an assisting object (assistant object) such as a mouse cursor or a marker. Even when the original image does not change be fore and after the cursor superimposition, e.g., when the original image on which the cursor is to be superimposed is a still image, for example, the display brightness will locally change only in areas around the cursor due to the superimposing di splay of the cursor. Then, when the cursor moves, the area where the display brightness changes (the brightness-changing area) also moves so as to follow the movement of the cursor. Such changes in the display brightness and movement of the brightness-changing area lead to the sense of awkwardness felt by the user (the sense of hindrance in terms of image quality).

Where the original image is a video image, even when there is no moving area in the original image (e.g., an area of a moving object), the display brightness of the original image may possibly change. The display brightness of the original image may change due to an image change that involves no movement, such as the superimposing display of a graphics image, a change in the brightness of the illumination present in the original image, and a fade effect added through a video editing operation, for example.

Therefore, there is a need to suppress only changes in display brightness due to the superimposing display of the cursor in such a manner that changes in display brightness due to image changes will not be suppressed.

### SUMMARY OF THE INVENTION

The present invention provides a technique capable of suppressing changes in display brightness due to the superimposing display of a predetermined object in such a manner that changes in display brightness due to image changes of the original image will not be suppressed.

The present invention in its first aspect provides a display apparatus comprising:

a light-emitting unit having a plurality of light sources of which emission brightness can be controlled individually;

a display unit configured to display an image on a screen by modulating light from the light-emitting unit;

a determination unit configured to determine, for each of the plurality of light sources, a target brightness based on a brightness of an image to be displayed in an area on the screen corresponding to the light source;

a first detection unit configured to detect, as a first block, an area in which a predetermined object is displayed, from among a plurality of areas corresponding to the plurality of light sources;

a second detection unit configured to detect, as a second block, an area in which no moving object is displayed, from among the plurality of areas;

a correction unit configured to correct a target brightness of a light source corresponding to a third block, which is an area which has been detected as a first block by the first detection unit and which has been detected as a second block by the second detection unit, on the basis of target brightnesses of surrounding light sources; and

a control unit configured to control, for each of the light sources, an emission brightness of the light source to the target brightness.

The present invention in its second aspect provides a display apparatus comprising:

a light-emitting unit having a plurality of light sources of which emission brightness can be controlled individually;

a display unit configured to display an image on a screen by modulating light from the light-emitting unit;

an obtaining unit configured to obtain, for each of the plurality of light sources, a characteristic value representing a brightness of an image to be displayed in an area on the screen corresponding to the light source;

a first detection unit configured to detect, as a first block, an area in which a predetermined object is displayed, from among a plurality of areas corresponding to the plurality of light sources;

a second detection unit configured to detect, as a second block, an area in which no moving object is displayed, from among the plurality of areas;

a correction unit configured to correct a characteristic value which has been obtained for a light source corresponding to a third block, which is an area which has been detected as a first block by the first detection unit and which has been detected as a second block by the second detection unit, on the basis of characteristic values which have been obtained for surrounding light sources; and

a control unit configured to control, for each of the light sources, an emission brightness of the light source to a value based on a characteristic value corresponding to the light source.

The present invention in its third aspect provides a method for controlling a display apparatus that includes:

a light-emitting unit having a plurality of light sources of which emission brightness can be controlled individually; and

a display unit configured to display an image on a screen by modulating light from the light-emitting unit,

the method comprising:

determining, for each of the plurality of light sources, a target brightness based on a brightness of an image to be displayed in an area on the screen corresponding to the light source;

detecting, as a first block, an area in which a predetermined object is displayed, from among a plurality of areas corresponding to the plurality of light sources;

detecting, as a second block, an area in which no moving object is displayed, from among the plurality of areas;

correcting a target brightness of a light source corresponding to a third block, which is an area which has been detected as a first block and which has been detected as a second block, on the basis of target brightnesses of surrounding light sources; and

controlling, for each of the light sources, an emission brightness of the light source to the target brightness.

The present invention in its fourth aspect provides a method for controlling a display apparatus that includes:

a light-emitting unit having a plurality of light sources of which emission brightness can be controlled individually; and

a display unit configured to display an image on a screen by modulating light from the light-emitting unit,

the method comprising:

obtaining, for each of the plurality of light sources, a characteristic value representing a brightness of an image to be displayed in an area on the screen corresponding to the light source;

detecting, as a first block, an area in which a predetermined object is displayed, from among a plurality of areas corresponding to the plurality of light sources;

detecting, as a second block, an area in which no moving object is displayed, from among the plurality of areas;

correcting a characteristic value which has been obtained for a light source corresponding to a third block, which is an area which has been detected as a first block and which has been detected as a second block, on the basis of characteristic values which have been obtained for surrounding light sources; and

controlling, for each of the light sources, an emission brightness of the light source to a value based on a characteristic value corresponding to the light source.

According to the present invention, it is possible to suppress changes in display brightness due to the superimposing display of a predetermined object in such a manner that changes in display brightness due to image changes of the original image will not be suppressed.

Further features of the present invention will become apparent from the following description of exemplary embodiments with reference to the attached drawings.

### BRIEF DESCRIPTION OF THE DRAWINGS

FIG. 1 is a diagram showing an example of a display image of a display apparatus according to Embodiment 1;

FIG. 2 is a block diagram showing an example of a functional configuration of the display apparatus according to Embodiment 1;

FIG. 3 is a flow chart showing an example of a process flow of the display apparatus according to Embodiment 1;

FIG. 4 is a diagram showing an example of various data used in Embodiment 1;

FIG. 5 is a block diagram showing an example of a functional configuration of a display apparatus according to Embodiment 2; and

FIG. 6 is a diagram showing an example of a display image of a conventional display apparatus.

### DESCRIPTION OF THE EMBODIMENTS

### Embodiment 1

A display apparatus according to Embodiment 1 of the present invention and a method for controlling the same will now be described.

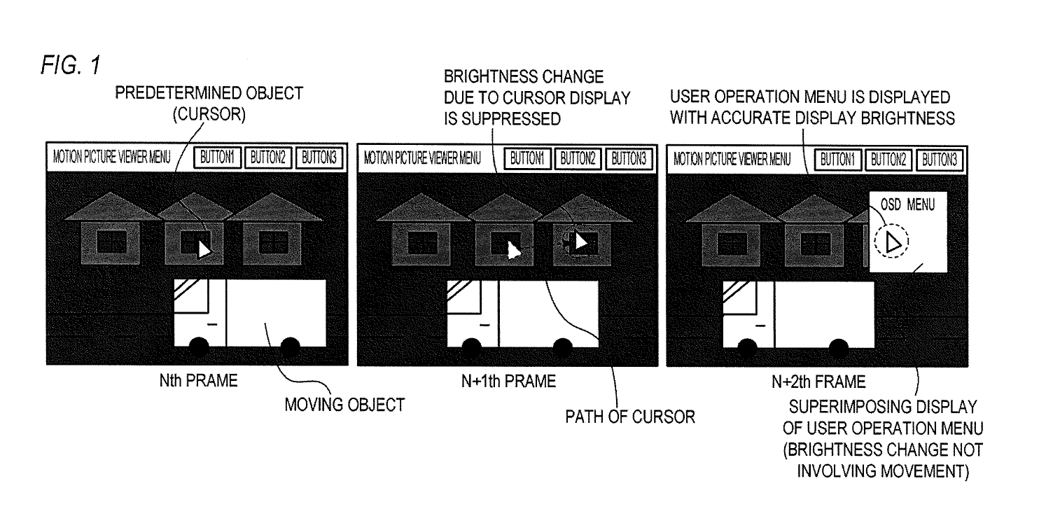

The display apparatus according to the present embodiment displays an image including an area of a moving object, an area of a predetermined object, an area of a user operation menu, and so on, as shown in FIG. 1, for example. Herein, areas other than the area of the moving object will be referred to as “semi-stationary areas”. A predetermined object is, for example, an assistant object for assisting in user operations. An assistant object is, for example, a cursor that is moved by the user's mouse operation. The present embodiment is directed to an example where the predetermined object is a cursor.

Note that although the present embodiment is directed to an example where the display apparatus is a transmissive liquid crystal display apparatus, the display apparatus is not limited to a transmissive liquid crystal display apparatus. The display apparatus may be any display apparatus as long as it is a display apparatus having an independent light source. For example, the display apparatus may be a reflective liquid crystal display apparatus. The display apparatus may be a MEMS shutter-type display using a micro electro mechanical system (MEMS) shutter, instead of a liquid crystal element.

(General Configuration)

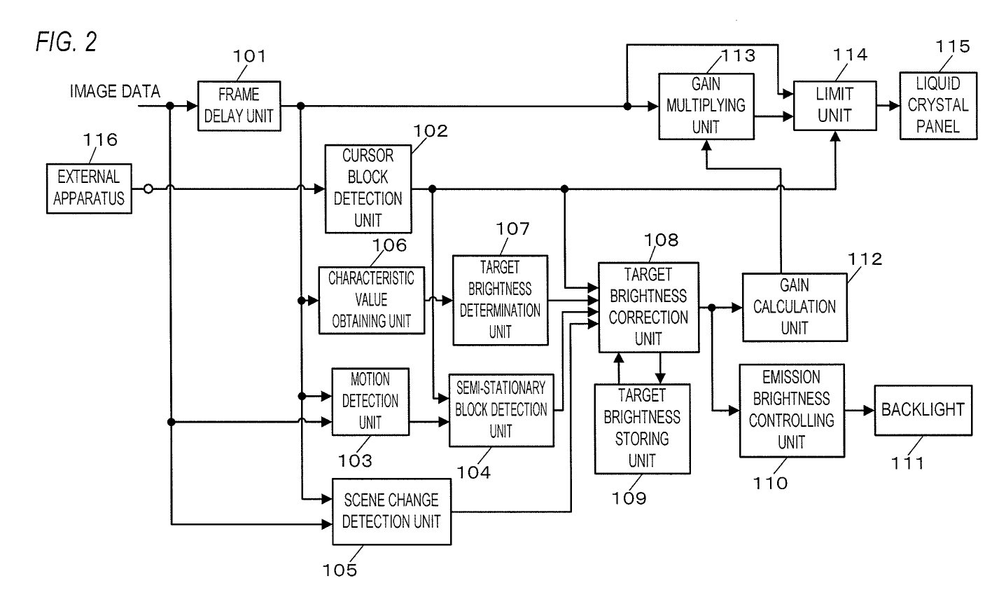

FIG. 2 is a block diagram showing an example of a functional configuration of the display apparatus according to the present embodiment.

A backlight 111 (backlight module) is a light-emitting unit having a plurality of light sources of which emission brightness can be controlled individually. The light source has one or more light-emitting member. The light-emitting member may be, for example, an LED, an organic EL element, a cold-cathode tube, or the like.

A liquid crystal panel 115 (LCD module) is a display unit for displaying an image on the screen (on the display surface) by modulating light from the backlight 111. Specifically, the liquid crystal panel 115 includes a plurality of liquid crystal elements and controls the transmittance of each liquid crystal element on the basis of image data. An image is displayed as the light from the backlight 111 passes through the liquid crystal elements.

A frame delay unit 101 outputs image data with a delay of one frame period. Herein, a frame of image data input to the display apparatus and input to the frame delay unit 101 will be referred to as the “input frame”, and a frame preceding the input frame will be referred to as the “target frame”. The frame delay unit 101 receives image data of the input frame, and outputs image data of the target frame. Specifically, the frame delay unit 101 has a memory for storing one frame of image data. Then, as the frame delay unit 101 receives image data of the input frame, the frame delay unit 101 reads out from the memory image data of the target frame stored in the memory and outputs the image data of the target frame, and stores image data of the input frame in the memory.

A cursor block detection unit 102 detects, as the object block (cursor block; first block), an area where the cursor is displayed, from among a plurality of areas on the screen corresponding to a plurality of light sources of the backlight 111 (first detection). In the present embodiment, as shown in FIG. 2, coordinate data representing the cursor display area is obtained from an external apparatus 116. The external apparatus 116 is a personal computer (PC), for example. The coordinate data is managed by an operating system (OS), application software, etc., running on the PC. The cursor block detection unit 102 detects, as the cursor block, an area that includes the display position (coordinates) represented by the obtained coordinate data, from among a plurality of areas corresponding to a plurality of light sources. Then, the cursor block detection unit 102 outputs the cursor block detection result.

Note that coordinate data of one point (one pixel) indicating the representative position of the cursor display area may be obtained from the PC. In such a case, coordinate data representing an area of a predetermined size including therein the representative position may be generated, on the basis of the obtained coordinate data, as coordinate data representing the cursor display area. For example, coordinate data of all pixels belonging to the area of a predetermined size including therein the representative position may be generated as coordinate data representing the cursor display area. Where the area of a predetermined size is a rectangular area, data of vertex coordinates of the rectangular area may be generated as the coordinate data representing the cursor display area.

Where the distance between the coordinates of the representative position and the divided area border to be described below is less than or equal to a predetermined value, a plurality of divided areas which form the border may be detected as a cursor block.

With these methods, it is possible to precisely detect the cursor block even when the cursor is present over a plurality of divided areas.

Note that the predetermined size and the predetermined value may each be a fixed value or a value that is changed in conjunction with user settings. If the predetermined size and the predetermined value are changed in conjunction with user settings, it is possible to precisely detect the cursor block even when the user has changed the cursor display size.

Note that the present embodiment defines a plurality of divided areas which define the screen area, as a plurality of areas corresponding to a plurality of light sources, but the present invention is not limited to this. For example, an area corresponding to a light source may be defined as an area that overlaps areas corresponding to other light sources, or as an area that is not in contact with areas corresponding to other light sources.

The present embodiment defines a plurality of divided areas different from one another as a plurality of areas corresponding to a plurality of light sources, but the present invention is not limited to this. For example, as an area corresponding to a light source, the same area as an area corresponding to another light source may be defined.

A motion detection unit 103 detects the motion of an image in each of the divided areas corresponding to a plurality of light sources. Herein, since there is a one-to-one correspondence between a plurality of light sources and a plurality of areas (divided areas), a “process to be performed for each light source” can be said to be a “process to be performed for each area (divided area)”, and a “value obtained for a light source” can be said to be a “value obtained for an area (divided area)”. Therefore, the process of the motion detection unit 103 can be said to be a “process for detecting the motion of an image in each of the divided areas”.

Specifically, the motion detection unit 103 detects, for each divided area, a motion vector between two frames that are continuous in time. In the present embodiment, the motion detection unit 103 receives image data of the input frame, and the target frame output from the frame delay unit 101. Then, the motion detection unit 103 detects, for each divided area, the motion vector between the input frame and the target frame. Then, the motion detection unit outputs the image motion detection result.

A semi-stationary block detection unit 104 detects, as semi-stationary blocks (second blocks), an area in which no moving object is displayed, from among a plurality of divided areas (second detection). Specifically, the semi-stationary block detection unit 104 detects the semi-stationary block on the basis of the image motion detection result (the detection result of the motion detection unit 103). Then, the semi-stationary block detection unit 104 outputs the semi-stationary block detection result.

A scene change detection unit 105 detects a switching between scenes (scene change), and outputs the scene change detection result. In the present embodiment, the scene change detection unit 105 receives image data of the input frame, and the target frame output from the frame delay unit 101. The scene change detection unit 105 calculates the average pixel value for each of the input frame and the target frame, and determines whether the difference between the average pixel value of the input frame and the average pixel value of the target frame is greater than or equal to a predetermined value. Then, if the difference is greater than or equal to the predetermined value, the scene change detection unit 105 determines that there is a scene change between the input frame and the target frame. If the difference is less than the predetermined value, the scene change detection unit 105 determines that there is no scene change between the input frame and the target frame.

Note that the scene change detection method is not limited to the method described above. Where information representing the switching between scenes is added as meta data to image data, the scene change may be detected using the information.

For each of a plurality of light sources of the backlight 111, the target brightness (initial target brightness) based on the brightness (luminance) of the image to be displayed in the divided area corresponding to the light source is determined by a characteristic value obtaining unit 106 and a target brightness determination unit 107.

For each of a plurality of light sources, the characteristic value obtaining unit 106 obtains and outputs a characteristic value representing the brightness of the image to be displayed in the divided area corresponding to the light source. The characteristic value is a representative value or a histogram of pixel values of image data representing an image to be displayed in the divided area, or a representative value or a histogram of brightness values of image data, etc. The representative value is the maximum value, the minimum value, the mode, the average value, the intermediate value, or the like. The present embodiment is directed to an example where the characteristic value is the maximum value of a pixel value (maximum pixel value).

Note that while it is assumed in the present embodiment that the characteristic value is obtained from image data of the target frame, the present invention is not limited to this. For example, the characteristic value may be obtained from outside. Specifically, the characteristic value may be added as meta data to image data.

For each of a plurality of light sources, the target brightness determination unit 107 determines the initial target brightness based on the characteristic value (the characteristic value of the target frame) obtained for the light source, and outputs information representing the initial target brightness of each light source. Specifically, the initial target brightnesses of the light sources are calculated so that the initial target brightness is higher in areas where the image is bright than in areas where the image is dark. Herein, a “characteristic value obtained for a light source” is a “characteristic value representing the brightness of the image to be displayed in a divided area corresponding to the light source” obtained in the characteristic value obtaining unit 106. For example, the initial target brightness is determined by using information (a function, a table, or the like) representing the correspondence between the characteristic value and the initial target brightness.

A target brightness correction unit 108 corrects the initial target brightness of a light source corresponding to a semi-stationary object block (semi-stationary cursor block; third block) on the basis of the initial target brightnesses of the surrounding light sources (correction process). A semi-stationary cursor block is an area that has been detected as a cursor block by the cursor block detection unit 102 and as a semi-stationary block by the semi-stationary block detection unit 104. Light sources located around a light source corresponding to a semi-stationary cursor block are, for example, light sources corresponding to divided areas adjacent to the semi-stationary cursor block. Hereinafter, the target brightness after the correction process will be referred to as the “final target brightness”.

Note that a light source located around a light source corresponding to a semi-stationary cursor block may be a light source provided at a position where the distance from the light source corresponding to the semi-stationary cursor block is less than or equal to a predetermined value.

Note that there is a one-to-one correspondence between a plurality of light sources and a plurality of areas (divided areas) as described above. Therefore, a “light source around the light source corresponding to the semi-stationary cursor block” can be said to be a “light source corresponding to an area around the semi-stationary cursor block”.

Then, the target brightness correction unit 108 outputs information representing the final target brightness of each light source. In the present embodiment, the final target brightness of a light source corresponding to a semi-stationary cursor block is a value that has been corrected on the basis of the initial target brightnesses of surrounding light sources. The final target brightness of the other light sources is the initial target brightness determined by the target brightness determination unit 107.

Note that the final target brightness of a light source corresponding to a semi-stationary cursor block may be a value that has undergone a correction process based on the target brightnesses of surrounding light sources, and another correction process of any type different from the above correction process. The final target brightness of the other light sources may be a value that has undergone a correction process of any type.

In the present embodiment, the target brightness correction unit 108 detects (selects) similar light sources from among a plurality of light sources located around a light source corresponding to a semi-stationary cursor block. That is, the target brightness correction unit 108 detects (selects) similar areas from among a plurality of areas (divided areas) located around the semi-stationary cursor block. In the present embodiment, a similar light source is a light source of which the initial target brightness obtained is similar to the initial target brightness which would be obtained for the light source corresponding to the semi-stationary cursor block if no cursor were displayed in the semi-stationary cursor block. A similar area is an area corresponding to a similar light source.

Specifically, the target brightness correction unit 108 selects, as a similar light source, a light source that satisfies Conditions 1 and 2 below, from among a plurality of light sources located around the light source corresponding to the semi-stationary cursor block.

(Condition 1) Corresponds to an area other than the cursor block (other than the object block).

(Condition 2) The difference in final target brightness in a past frame from the light source corresponding to the semi-stationary cursor block is less than or equal to a threshold value.

Then, the target brightness correction unit 108 brings the initial target brightness of the light source corresponding to the semi-stationary cursor block in the current frame closer to the initial target brightness of a selected similar light source in the current frame, and outputs the result as the final target brightness.

Herein, a “past frame” is a frame in the past with respect to the target frame, and a “current frame” is the target frame.

Note that while it is assumed in the present embodiment that a past frame is the frame preceding the target frame (the second frame before the input frame), the present invention is not limited to this. For example, a past frame may be the second frame before the target frame.

Note that the threshold value for detecting a similar light source may or may not be a fixed value determined in advance by the manufacturer, or the like. For example, the threshold value may be a value that can be set or changed by the user.

Note that Conditions 1 and 2 above may be replaced by Conditions 3 and 4 below to detect an area (divided area) that satisfies Conditions 3 and 4 below as a similar area.

(Condition 3) Is an area other than the cursor block.

(Condition 4) Corresponds to a light source of which the difference in final target brightness in a past frame from the light source corresponding to the semi-stationary cursor block is less than or equal to a threshold value.

A target brightness storing unit 109 stores the final target brightnesses of the light sources. In the present embodiment, when a correction process is performed by the target brightness correction unit 108, the final target brightnesses of the light sources in the past frame (the frame preceding the target frame) are stored in the target brightness storing unit 109. Then, the target brightness storing unit 109 outputs the final target brightnesses of the light sources in the past frame to the target brightness correction unit 108, and obtains and stores the final target brightnesses of the light sources (the final target brightnesses in the target frame) output from the target brightness correction unit 108.

For each light source of the backlight 111, an emission brightness controlling unit 110 controls the emission brightness of the light source to the final target brightness output from the target brightness correction unit 108. Specifically, for each light source, the emission brightness controlling unit 110 determines the backlight control value based on the final target brightness of the light source, and outputs the backlight control value of the light source. For example, where the emission brightness is control led by pulse width modulation, a pulse width value is output as the backlight control value. Where the emission brightness is controlled by pulse amplitude modulation, a pulse amplitude value is output as the backlight control value. Where the emission brightness is controlled by modulating both the pulse width and the pulse amplitude, a combination of a pulse width value and a pulse amplitude value is output as the backlight control value. Each light source of the backlight 111 is lit with an emission brightness based on the backlight control value output from the emission brightness controlling unit 110 (the final target brightness output from the target brightness correction unit 108).

A gain calculation unit 112 calculates, for each pixel, the brightness on the screen of the display apparatus (display brightness; first display brightness) when the backlight 111 is lit with a backlight control value output from the emission brightness controlling unit 110. Then, the gain calculation unit 112 calculates the multiplier (gain) so that the maximum value of the first display brightness coincides with the maximum value of the display brightness (second display brightness) when the backlight 111 is lit with a predetermined emission brightness. Note that the display brightness may be calculated for each divided area, rather than for each pixel.

A gain multiplying unit 113 multiplies the image data of the target frame (pixel values of the target frame) by the gain calculated by the gain calculation unit 112, and outputs the image data of the target frame multiplied by the gain.

A limit unit 114 performs a limit process on the image data output from the gain multiplying unit 113. In the limit process, if the pixel value of the cursor block exceeds the upper limit value, the pixel value is substituted for the pixel value before the gain multiplication. When a pixel value of an area other than the cursor block exceeds the upper limit value, the pixel value is substituted for the upper limit value. Then, the limit unit 114 outputs the image data after the limit process to the liquid crystal panel 115. On the liquid crystal panel 115, the transmittance of each liquid crystal element is controlled on the basis of the image data after the limit process.

Specifically, the limit unit 114 obtains image data of the target frame before the gain multiplication from the frame delay unit 101, and obtains image data of the target frame after the gain multiplication from the gain multiplying unit 113. The limit unit 114 obtains the cursor block detection result from the cursor block detection unit 102. Then, for those pixels of which the pixel value does not exceed the upper limit value, the limit unit 114 outputs, as the pixel value, the pixel value after the gain multiplication (the value of the image data obtained from the gain multiplying unit 113). For those pixels which are within the cursor block and of which the pixel value exceeds the upper limit value, the limit unit 114 outputs, as the pixel value, the pixel value before the gain multiplication (the value of the image data obtained from the frame delay unit 101). For those pixels which are outside the cursor block and of which the pixel value exceeds the upper limit value, the limit unit 114 outputs the upper limit value as the pixel value.

(Motion Detection Unit)

The motion detection unit 103 will be described in detail.

The motion detection unit 103 detects the motion of the image for each divided area (each light source) using a block matching method.

First, the motion detection unit 103 selects one divided area as an area of interest, and extracts an image of the target frame in the area of interest as an image of interest.

Next, the motion detection unit 103 defines a reference area of the same size as the area of interest, and extracts an image of the input frame in the reference area as a reference image.

Then, the motion detection unit 103 calculates the correlation value between the image of interest and the reference image. For example, for each pixel, the absolute value of difference (absolute difference) between the pixel value of the image of interest and the pixel value of the reference image is calculated. Then, the sum of absolute difference (SAD) for each pixel is calculated as the correlation value.

Note that the correlation value is not limited to SAD. The correlation value may be any value as long as it represents the degree of similarity between the image of interest and the reference image. For example, the difference between the average pixel value of the image of interest and the average pixel value of the reference image may be calculated as the correlation value.

The motion detection unit 103 defines a reference area for each of a plurality of positions, and calculates the correlation value for a plurality of reference areas. For example, the correlation value is calculated for the plurality of reference areas by moving through the reference areas so as to scan the image of the input frame.

Note that the reference areas may be defined in any manner. For each divided area, the divided area may be defined as a reference area. A plurality of reference areas may be defined by moving a reference area by one pixel or a plurality of pixels at a time.

Then, the motion detection unit 103 detects, as the corresponding area, an area that has the highest correlation value, from among the plurality of reference areas, and the amount of shift of the position of the corresponding area with respect to the position of the area of interest is calculated as the motion vector for the area of interest (the light source corresponding to the area of interest). The area having the highest correlation value is the area having the smallest SAD. Where the horizontal shift amount is Vx pixels and the vertical shift amount is Vy pixels, the position vector (Vx, Vy) with respect to the position of the area of interest as the origin is detected as the motion vector.

Note that the method for detecting the motion of the image is not limited to the method described above. A value other than the motion vector may be detected as the motion of the image. For example, for each divided area, the amount of change in image between the input frame and the target frame may be calculated so that it is determined that “there is motion” when the amount of change is greater than or equal to a threshold value, and “there is no motion” when the amount of change is less than the threshold value.

The threshold value for detecting the presence/absence of motion may or may not be a fixed value determined in advance by the manufacturer, or the like. For example, the threshold value may be a value that can be set or changed by the user.

Note that while it is assumed in the present embodiment that the size of an area of interest and the size of a reference area are the same as the size of a divided area, the present invention is not limited to this. An area of interest and a reference area may be larger or smaller than a divided area. Where an area accounting for two or more divided areas is defined as the area of interest, the motion vector detected for the area of interest may be used as the motion vector for each divided area in the area of interest, for example. Where a plurality of areas of interest are defined sharing the same divided area, a representative value (the average value, the mode, or the intermediate value) of the motion vectors detected for areas of interest sharing the same divided area may be used as the motion vector of the divided area, for example.

(Semi-Stationary Block Detection Unit)

The semi-stationary block detection unit 104 will be described in detail.

The semi-stationary block detection unit 104 stores the detection result of the motion detection unit 103. Specifically, the semi-stationary block detection unit 104 stores the detection result of the motion detection unit 103 in a memory (not shown). Then, the semi-stationary block detection unit 104 detects a semi-stationary block on the basis of the stored image motion detection result.

First, the semi-stationary block detection unit 104 obtains the detection result of the cursor block detection unit 102 and the detection result of the motion detection unit 103 (motion vector).

Then, for the divided areas other than the cursor block (light sources corresponding to the divided areas other than the cursor block), the semi-stationary block detection unit 104 updates the stored motion vector with the obtained motion vector (the motion vector detected for the target frame).

For the cursor block (the light source corresponding to the cursor block), the semi-stationary block detection unit 104 does not update, but retains, the stored motion vector. Thus, for the cursor block, it is possible to store a motion vector close to a motion vector that is detected when the cursor is not displayed (a motion vector representing the motion of the image in an area other than the cursor). Specifically, for the cursor block, it is possible to store a motion vector that is detected immediately before the cursor is displayed.

Note that when the cursor is stationary, the motion vector of the cursor block may be updated. Whether the cursor is stationary can be determined by determining whether the cursor display position represented by the coordinate data obtained from an external apparatus is changing, for example.

Next, for each divided area, the semi-stationary block detection unit 104 selects the divided area as the process object.

Then, the semi-stationary block detection unit 104 detects, as a semi-stationary block, the divided area of the process object when the stored motion vector is of a value representing no motion of the image for all of the divided area of the process object and divided areas adjacent to the divided area.

Note that while it is assumed in the present embodiment that a motion vector representing no motion of the image is a zero vector, the present invention is not limited to this. For example, a motion vector of which magnitude is less than or equal to a predetermined value, which is greater than 0, may be determined to be a motion vector representing no motion of the image.

The predetermined value for detecting the semi-stationary block may or may not be a fixed value determined in advance by the manufacturer, or the like. For example, the predetermined value may be a value that can be set or changed by the user.

Note that the method for detecting the semi-stationary block is not limited to the method described above.

For example, each divided area for which the stored motion vector is a zero vector may be detected as a semi-stationary block. Each divided area for which the stored motion vector is a zero vector for a plurality of consecutive frames may be detected as a semi-stationary block. Specifically, each divided area for which the stored motion vector is a zero vector for two consecutive frames may be detected as a semi-stationary block. By using motion vectors for a plurality of frames, it is possible to prevent an area including a moving object therein from being erroneously detected as a semi-stationary block when the moving object becomes stationary temporarily.

Each area corresponding to a light source having therearound a predetermined number or more of light sources for which no motion of the image is detected by the motion detection unit 103 may be detected as a semi-stationary block. That is, each area (divided area) having therearound a predetermined number or more of areas (divided areas) for which no motion of the image is detected by the motion detection unit 103 may be detected as a semi-stationary block. With such a configuration, even when a motion vector close to a motion vector that is detected when the cursor is not displayed is not detected as the motion vector for the cursor block, it is possible to precisely determine whether the cursor block is a semi-stationary block. Therefore, a motion vector detected for the target frame may be used as the motion vector of each divided area (each light source).

The predetermined number for detecting the semi-stationary block may or may not be a fixed value determined in advance by the manufacturer, or the like. For example, the predetermined number may be a value that can be set or changed by the user.

(Target Brightness Correction Unit)

The target brightness correction unit 108 will be described in detail.

The target brightness correction unit 108 obtains the initial target brightness for the target frame from the target brightness determination unit 107. The target brightness correction unit 108 obtains the final target brightness for the frame preceding the target frame from the target brightness storing unit 109. The target brightness correction unit 108 obtains the detection result of the cursor block detection unit 102, the detection result of the semi-stationary block detection unit 104, and the detection result of the scene change detection unit 105.

The target brightness correction unit 108 determines, as a semi-stationary cursor block, a divided area that has been detected as a cursor block and that has been detected as a semi-stationary block.

If a scene change is detected by the scene change detection unit 105, the target brightness correction unit 108 does not perform the correction process, but outputs, as the final target brightness, the initial target brightness of each light source obtained from the target brightness determination unit 107.

If no scene change is detected by the scene change detection unit 105, the target brightness correction unit 108 performs the following process.

That is, the target brightness correction unit 108 detects similar light sources from among a plurality of light sources located around the light source corresponding to the semi-stationary cursor block. In the present embodiment, detected as a similar light source is a light source of which the initial target brightness is closest to the initial target brightness which would be obtained for the light source corresponding to the semi-stationary cursor block if no cursor were displayed in the semi-stationary cursor block. Specifically, the final target brightness in the frame preceding the target frame is referenced. Then, a light source that satisfies Conditions 1 and 2 below, from among a plurality of light sources located around the light source corresponding to the semi-stationary cursor block, is selected as a similar light source.

(Condition 1) Corresponds to an area other than the cursor block.

(Condition 2) The difference in final target brightness in a past frame from the light source corresponding to the semi-stationary cursor block is less than or equal to a threshold value.

If there are a plurality of light sources that satisfy Conditions 1 and 2 above, a light source for which the difference in final target brightness is smallest, from among the plurality of light sources, is selected as a similar light source.

Then, the target brightness correction unit 108 substitutes the initial target brightness in the target frame of the light source corresponding to the semi-stationary cursor block, for the initial target brightness in the target frame of the selected similar light source, and outputs it as the final target brightness.

For each light source corresponding to a divided area other than the semi-stationary cursor block, the target brightness correction unit 108 outputs, as the final target brightness, the initial target brightness of the light source obtained from the target brightness determination unit 107. Therefore, where there is no similar light source, the correction process is not performed, and the initial target brightness of the light source obtained from the target brightness determination unit 107 is output as the final target brightness.

(Process Flow)

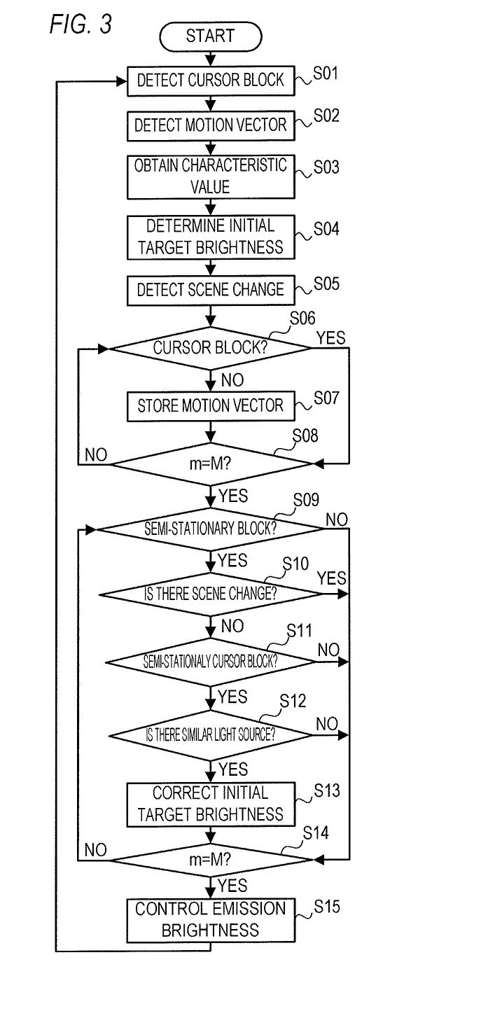

An example of a process flow of the display apparatus according to the present embodiment will be described with reference to FIG. 3.

FIG. 3 is a flow chart showing an example of a flow of the process (the process of lighting the backlight 111) of the display apparatus according to the present embodiment.

In S01, the cursor block detection unit 102 detects a cursor block.

In S02, the motion detection unit 103 detects the motion vector for each divided area.

In S03, the characteristic value obtaining unit 106 obtains the characteristic value for each divided area from the image data of the target frame. As described above, in the present embodiment, the maximum pixel value is obtained as the characteristic value.

In S04, for each divided area, the target brightness determination unit 107 determines the initial target brightness BL(n) of a light source corresponding to the divided area on the basis of the maximum pixel value of the divided area obtained in S03. Here, n is an integer representing the frame number of the target frame, and the initial target brightness BL(n) is the initial target brightness in the target frame. In the present embodiment, the light sources are numbered so that the number increases from upper left to lower right on the screen. This number can also be said to be the divided area number. Specifically, the backlight 111 includes M light sources (M is an integer of 2 or more), and the M light sources are each numbered with a number of 1 or more and M or less so that the number increases one by one from upper left to lower right on the screen. Hereinbelow, BL(n) (m) denotes the target brightness (the initial target brightness or the final target brightness) of the mth (m is an integer of 1 or more and M or less) light source in the target frame.

In S05, the scene change detection unit 105 detects a scene change.

In S06, the semi-stationary block detection unit 104 determines whether the mth divided area (the divided area corresponding to the mth light source; divided area m) is a cursor block on the basis of the detection result from S01. Note that the initial value of m is 1.

If the divided area m is a cursor block, the process proceeds to S08.

If the divided area m is not a cursor block, the process proceeds to S07.

In S07, the semi-stationary block detection unit 104 stores the motion vector of the divided area m (the motion vector detected in S02). Then, the process proceeds to S08.

In S08, the semi-stationary block detection unit 104 determines whether m=M. That is, it is determined whether the process of S06 has been performed for all the divided areas.

If m=M, the process proceeds to S09. That is, if the process of S06 has been performed for all the divided areas, the process proceeds to S09. Note that when the process proceeds to S09, m is initialized to 1.

If m<M, 1 is added to m, and the process returns to S06. That is, if there are divided areas for which the process of S06 has not been performed, the divided area of the process object is updated, and the process returns to S06.

In S09, the semi-stationary block detection unit 104 determines whether the divided area m is a semi-stationary block. Specifically, it is determined whether the stored motion vector is a zero vector for all of the divided area m and divided areas adjacent to the divided area m.

If the stored motion vector is a zero vector for all of the divided area m and divided areas adjacent to the divided area m, the semi-stationary block detection unit 104 determines that the divided area m is a semi-stationary block. Then, the semi-stationary block detection unit 104 outputs the motion vector of the divided area m determined in S02 to the target brightness correction unit 108. Then, the process proceeds to S10.

Otherwise, the semi-stationary block detection unit 104 determines that the divided area m is not a semi-stationary block. Then, the semi-stationary block detection unit 104 outputs the motion vector of the divided area m determined in S02 to the target brightness correction unit 108. Then, the process proceeds to S14.

In S10, the target brightness correction unit 108 determines whether a scene change has been detected in S05 on the basis of the detection result from S05.

If a scene change has been detected, the process proceeds to S11.

If no scene change has been detected, the process proceeds to S14.

In S11, the target brightness correction unit 108 determines whether the divided area m is a semi-stationary cursor block. Specifically, the target brightness correction unit 108 determines that the divided area m is a semi-stationary cursor block if the divided area m has been detected in S01 as a cursor block, and otherwise determines that the divided area m is not a semi-stationary cursor block.

If the divided area m is a semi-stationary cursor block, the process proceeds to S12.

If the divided area m is not a semi-stationary cursor block, the process proceeds to S14.

In S12, the target brightness correction unit 108 determines whether there are similar light sources. Specifically, as described above, the final target brightness BL(n−1) in the frame preceding the target frame is referenced. Then, from among light sources corresponding to divided areas adjacent to the divided area m, those that satisfy Conditions 1 and 2 below are detected as similar light sources.

(Condition 1) Corresponds to an area other than the cursor block.

(Condition 2) A final target brightness BL(n−1) has been set such that the difference from the final target brightness BL(n−1) (m) is less than or equal to a threshold value.

If there are a plurality of light sources that satisfy Conditions 1 and 2 above, a light source for which a final target brightness BL(n−1) has been set which has the smallest difference from the final target brightness BL(n−1)(m), from among the plurality of light sources, is detected as a similar light source. The final target brightness BL(n−1) is the final target brightness in the frame preceding the target frame. The final target brightness BL(n−1)(m) is the final target brightness of the light source corresponding to the divided area m in the frame preceding the target frame. Herein, S denotes the number of the similar light source, and the divided area corresponding to the Sth light source will be referred to as the “divided area S”.

If a similar light source has been detected, the process proceeds to S13.

If no similar light source has been detected, the process proceeds to S14.

In S13, the target brightness correction unit 108 substitutes the initial target brightness BL(n) (m) for the initial target brightness BL(n)(S). As described above, the initial target brightness BL(n) (m) is the target brightness of the light source corresponding to the divided area m in the target frame. Then, the initial target brightness BL(n) (S) is the target brightness of the light source corresponding to the divided area S (the divided area corresponding to the similar light source; similar area) in the target frame.

Then, the process proceeds to S14.

In S14, the target brightness correction unit 108 determines whether m=M.

If m=M, the process proceeds to S15.

If m<M, 1 is added to m, and the process returns to S09.

In S15, the target brightness correction unit 108 outputs the initial target brightness BL(n) of each light source as the final target brightness, the emission brightness controlling unit 110 controls the emission brightness of each light source to the final target brightness BL(n). Then, the process object is switched to the next frame, and the process returns to S01.

(Effects)

The effects of the present invention will now be described.

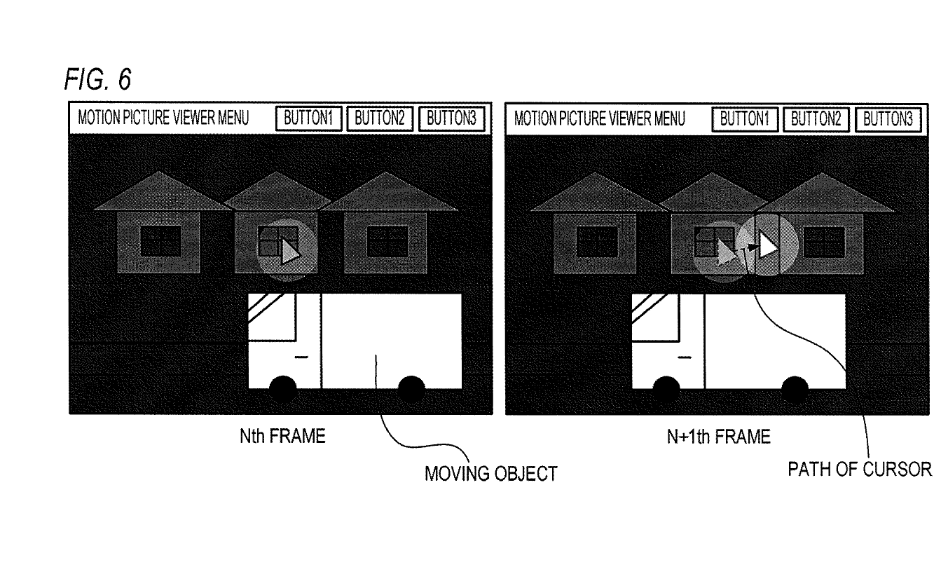

First, an example of a conventional technique will be described with reference to FIG. 6.

FIG. 6 is a diagram showing an example of a displayed image (an image displayed on the screen) in a conventional display apparatus for controlling the emission brightness of each light source on the basis of the brightness characteristic value of the image data of one frame. In FIG. 6, the displayed image includes a moving object, a cursor, a user operation menu, and so on. FIG. 6 shows the cursor being moved by a user using a mouse, or the like.

With a conventional display apparatus, the emission brightness of the light source corresponding to the divided area including the cursor therein is determined on the basis of the brightness characteristic value obtained while taking into consideration the pixel value of the cursor. Therefore, as the cursor is displayed, the display brightness around the cursor will change locally. For example, if the image of the cursor is a bright image, the emission brightness of the light source corresponding to the divided area including the cursor therein becomes higher than when the cursor is not included therein. Therefore, the di splay brightness around the cursor increases locally. Then, as the cursor moves, the area where the display brightness changes moves so as to follow the movement of the cursor. Such changes in the display brightness lead to the sense of awkwardness felt by the user (the sense of hindrance in terms of image quality).

Particularly, the sense of hindrance will be significant when the cursor is displayed in a divided area other than divided areas including a moving object therein. Specifically, a user normally focuses not on the cursor itself, but on the area around the cursor. Then, if no moving object is present around the cursor, the user's point of view is considered to be always within an area around the cursor. Therefore, if the cursor is displayed in a divided area other than divided areas including a moving object therein, the local change in the display brightness in an area around the cursor will be easily visually recognized and conspicuous. Note that if a moving object is present around the cursor, the user's point of view also moves following the moving object, and the local change in the display brightness in the area around the cursor will not be conspicuous.

Next, a display apparatus according to the present embodiment will be described.

According to the present embodiment, it is possible to suppress changes in the display brightness due to superimposing display of the cursor (a predetermined object) so that changes in the display brightness due to image changes of the original image will not be suppressed.

The effects described above and the reason why the effects are obtained will now be described in detail. The original image is an image before the cursor is superimposed.

In the present embodiment, a similar light source is detected if it is determined that a cursor is displayed in a divided area including no moving object therein. In other words, a similar light source is detected if the cursor block is a semi-stationary cursor block detected as a semi-stationary block. A similar light source is a light source of which the initial target brightness obtained is similar to the initial target brightness which would be obtained for the light source corresponding to the semi-stationary cursor block if no cursor were displayed in the semi-stationary cursor block. Then, the initial target brightness of the light source corresponding to the semi-stationary cursor block is substituted for the initial target brightness of the similar light source, and the emission brightness of the light source corresponding to the semi-stationary cursor block is controlled to the same value as the emission brightness of the similar light source.

Thus, when a cursor is displayed in a divided area including no moving object therein, as shown in FIG. 1, it is possible to suppress the local change in the display brightness around the cursor (image quality deterioration). If the brightness value of the image data in an area around the cursor changes due to image changes not involving movements, it is possible to change the emission brightness of the light source corresponding to the semi-stationary cursor block in accordance with the change in the brightness value. As a result, where a cursor is displayed in a divided area including no moving object therein, even if the brightness value of the image data in an area around the cursor changes due to image changes not involving movements, it is possible to display the area around the cursor with an accurate display brightness.

Thus, in the present embodiment, it is possible to suppress changes in the display brightness due to superimposing display of the cursor so that changes in the display brightness due to image changes of the original image will not be suppressed.

If the emission brightness is controlled so that changes in the display brightness due to superimposing display of the cursor are suppressed, the emission brightness of the light source corresponding to the cursor block may be controlled to a low value even though the pixel value of the cursor is a high value (a high brightness pixel value). In such a case, since the gain by which the pixel value of the cursor is multiplied increases, the pixel value of the cursor may be saturated at the upper limit value. The pixel value saturation leads to image quality deteriorations such as a decrease in contrast and a pixel color change. For example, if only a sub-pixel of a particular color is saturated, from among sub-pixels of three colors, i.e., the R sub-pixel, the G sub-pixel and the B sub-pixel, making up a pixel, the color of the pixel changes.

In the present embodiment, the limit unit 114 outputs as the pixel value the pixel value before the gain multiplication for any pixel which is within the cursor block and of which the pixel value exceeds the upper limit value. Thus, it is possible to prevent the pixel value of the cursor from being saturated, and it is possible to display the cursor while suppressing image quality deteriorations.

(Specific Examples of Process and Effect)

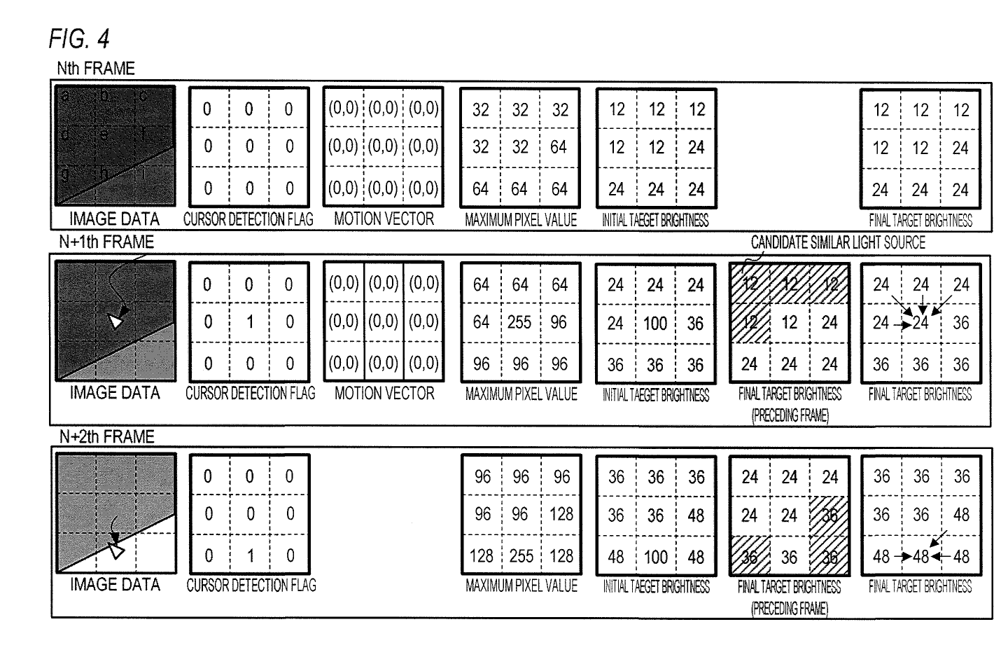

Specific examples of the process and effect of the display apparatus according to the present embodiment will be described with reference to FIG. 4.

FIG. 4 is a diagram showing an example of various data used in the present embodiment.

Data shown in the top row of FIG. 4 represents data of the Nth frame. Data shown in the middle row represents data of the N+1th frame. Data shown in the bottom row represents data in the N+2th frame. The Nth to N+2th frames are frames of the same scene.

Data shown in the leftmost column (the first column from the left) of FIG. 4 is image data which has been input to the display apparatus. Specifically, FIG. 4 shows a partial area of an image represented by the image data. The nine areas a to i, which are obtained by dividing an area bordered by a thick solid line with thin broken lines, are each a divided area. FIG. 4 shows the gradual increase in the brightness value of the image data through a fade effect. FIG. 4 shows that no moving object is present in the divided areas a to i, with the cursor moving into the divided area e from a divided area other than the divided areas a to i in the N+1th frame, and the cursor moving into the divided area h from the divided area e in the N+2th frame.

Data shown in the second column from the left of FIG. 4 represents the detection result of the cursor block detection unit 102 (a cursor detection flag).

The cursor block detection unit 102 outputs, as the detection result, information in which a cursor block is assigned a cursor detection flag “1” and divided areas other than the cursor block are assigned a cursor detection flag “0”.

Note that the detection result output from the cursor block detection unit 102 is not limited to the information described above. For example, only the cursor detection flag for the cursor block may be output.

Data shown in the third column from the left of FIG. 4 represents the motion vector stored in the semi-stationary block detection unit 104.

The semi-stationary block detection unit 104 obtains a motion vector with respect to the following frame from the motion detection unit 103, and obtains the cursor detection flag from the cursor block detection unit 102. Then, the semi-stationary block detection unit 104 updates the stored motion vector with the obtained motion vector only for divided areas where the cursor detection flag is 0.

For example, in the Nth frame, the cursor detection flags of the divided areas a to i are all 0. Therefore, in the Nth frame, the semi-stationary block detection unit 104 updates the stored motion vectors of the divided areas a to i with the obtained motion vector (a zero vector).

In the N+1th frame, the cursor detection flag of the divided area e, from among the divided areas a to i, is 1, and the cursor detection flag is 0 for the remaining eight divided areas. Therefore, in the N+1th frame, the semi-stationary block detection unit 104 updates the stored motion vectors of the remaining eight divided areas with the obtained motion vector (a zero vector) without updating the stored motion vector of the divided area e.

Then, the semi-stationary block detection unit 104 detects the divided area of the process object as a semi-stationary block if the stored motion vector is a zero vector for all of the divided area of the process object and divided areas adjacent to the divided area. Herein, it is assumed that the divided areas a to i have all been detected as a semi-stationary block.

Data shown in the fourth column from the left of FIG. 4 shows the maximum pixel value obtained by the characteristic value obtaining unit 106. FIG. 4 shows an example where the image data is 8-bit data, and the value of the image data (the pixel value) can possibly take a value from 0 to 255. FIG. 4 shows an example where the pixel value of the cursor is 255. Since the pixel values other than the cursor are gradually increased through a fade effect, FIG. 4 shows the maximum pixel values of the divided areas other than the cursor block gradually increasing.

Data shown in the fifth column from the left of FIG. 4 shows the initial target brightnesses determined by the target brightness determination unit 107 on the basis of the maximum pixel values (the maximum pixel values obtained by the characteristic value obtaining unit 106). FIG. 4 shows the percentage (0 to 100%) of the initial target brightness determined by the target brightness determination unit 107 with respect to the maximum value (maximum brightness) that the target brightness can possibly take. FIG. 4 shows an example where the maximum brightness is obtained as the initial target brightness when the maximum pixel value is 255. Therefore, the percentage is 100 in a divided area including the cursor therein.

The sixth column from the left of FIG. 4 shows the final target brightness in the preceding frame.

The seventh column from the left of FIG. 4 shows the final target brightness in the corresponding frame.

In the present invention, a divided area of which the cursor detection flag is “1” and of which the motion vector stored by the semi-stationary block detection unit 104 is 0, as is the divided area e in the N+1th frame, is determined as a semi-stationary cursor block.

Next, a similar light source is detected from among the eight light sources corresponding to the eight divided areas adjacent to the semi-stationary cursor block. Specifically, light sources that satisfy Conditions 1 and 2 below are detected as similar light sources.

(Condition 1) Corresponds to an area other than the cursor block.

(Condition 2) The difference in final target brightness in a past frame from the light source corresponding to the semi-stationary cursor block is less than or equal to a threshold value.

If there are a plurality of light sources that satisfy Conditions 1 and 2 above, a light source for which the difference in final target brightness is smallest, from among the plurality of light sources, is detected as a similar light source. For example, in the N+1th frame, the final target brightness of the divided area e in the preceding frame (Nth frame) is 12, and the final target brightness of the divided areas a, b, c and d (divided areas adjacent to the divided area e) in the preceding frame is also 12. Therefore, in the N+1th frame, one of the four light sources corresponding to the four divided areas a, b, c and d is selected as a similar light source.

Then, the initial target brightness of the light source corresponding to the semi-stationary cursor block in the current frame is substituted for the initial target brightness of the similar light source in the current frame and output as the final target brightness. In the N+1th frame, the initial target brightnesses of the divided areas a, b, c and d are all 24. Therefore, in the N+1th frame, the initial target brightness of the divided area e is corrected from 100 (the value shown in the fifth column from the left of FIGS. 4) to 24 (the value shown in the seventh column from the left of FIG. 4).

Note that if there are a plurality of candidate similar light sources, a light source which has the highest initial target brightness in the current frame, from among the plurality of candidates, is preferably selected as a similar light source. For example, in the N+1th frame, if the initial target brightness of the divided areas a, b and c is 24 and the initial target brightness of the divided area d is 30, the light source corresponding to the divided area d is preferably selected as a similar light source. Then, it is possible to prevent the emission brightness (backlight brightness) from being insufficient, and to suppress changes in the display brightness of the cursor.

By performing the process described above, in the N+1 th frame, the emission brightness of the light source corresponding to the divided area e is not controlled to 100 (the value determined on the basis of the brightness of the image). Then, following the image changes of the original image (a fade effect), the emission brightness of the light source corresponding to the divided area e is increased from 12 to 24. Thus, it is possible to suppress changes in display brightness due to the superimposing display of the cursor (the predetermined object) in such a manner that changes in display brightness due to image changes of the original image will not be suppressed, and it is therefore possible to display an image with no sense of awkwardness in terms of image quality.

Note that while it is assumed in the present embodiment that the coordinate data representing the cursor display area is obtained from outside, and the cursor block is detected by using the coordinate data, the present invention is not limited to this. For example, the cursor block may be detected by analyzing the image data. Specifically, it may be determined whether the first condition and the second condition below are satisfied for each divided area so as to detect, as the cursor block, a divided area that satisfies both the first condition and the second condition. Then, after the cursor block is detected, the divided area which has been detected as the cursor block may continue to be determined to be the cursor block until it no longer satisfies either the first condition or the second condition. That is, after the cursor block is detected, the divided area which has been detected as the cursor block may continue to be determined to be the cursor block if it satisfies at least one of the first condition and the second condition.

First condition: The characteristic value corresponding to the subject block (the divided area for which it is determined whether it satisfies a condition) is greater, by a predetermined value, than the maximum value of the characteristic value corresponding to a plurality of divided areas (adjacent blocks) adjacent to the subject block.

Second condition: The absolute value of the motion vector of the subject block is greater than 0, and the motion vector is 0 for all the adjacent blocks.

Note that while the present embodiment is directed to an example where the initial target brightness of the light source corresponding to the semi-stationary cursor block is substituted for the initial target brightness of the similar light source, the present invention is not limited to this.

The initial target brightness of the light source corresponding to the semi-stationary object block may be corrected in any manner as long as it is corrected on the basis of the initial target brightnesses of the surrounding light sources. Note, however, that the initial target brightness of the area including a moving object therein may possibly change due to the movement of the moving object. Then, if the initial target brightness changes in a similar manner to the initial target brightness of the semi-stationary cursor block which would be obtained if no cursor were displayed in the semi-stationary cursor block is believed to be a semi-stationary block with no cursor included therein. Therefore, it is preferred that the initial target brightness of the light source corresponding to the semi-stationary cursor block is corrected on the basis of the initial target brightness of a light source corresponding to a semi-stationary block that has not been detected as a cursor block, from among a plurality of surrounding light sources. Then, the effects described above can be realized more reliably.

As long as the initial target brightness of the light source corresponding to the semi-stationary cursor block can be brought closer to the initial target brightness of a similar light source, the final target brightness of the light source corresponding to the semi-stationary cursor block does not need to coincide with the final target brightness of the similar light source. Note, however, that it is believed that if no cursor were displayed in the semi-stationary cursor block, a value very close to the initial target brightness of a similar light source would be obtained as the initial target brightness of the light source corresponding to the semi-stationary cursor block. Therefore, by substituting the initial target brightness of the light source corresponding to the semi-stationary cursor block for the initial target brightness of the similar light source, the effects described above can be obtained more reliably.

While in the present embodiment, if there are a plurality of light sources that satisfy Conditions 1 and 2 above around the light source corresponding to the semi-stationary cursor block, a light source having the smallest difference in final target brightness, from among the plurality of light sources is selected as the similar light source, the present invention is not limited to this. Any light source may be selected as the similar light source as long as its difference in final target brightness is less than or equal to a threshold value. Note, however, that the light source having the smallest difference in final target brightness is likely to have its initial target brightness change in a similar manner to the initial target brightness of the semi-stationary cursor block which would be obtained if no cursor were displayed in the semi-stationary cursor block. Therefore, by selecting the light source having the smallest final target brightness as the similar light source, the effects described above can be obtained more reliably.

Note that while the present embodiment is directed to a configuration where a scene change is detected, no scene change may be detected. Even if no scene change is detected, the effects described above can be obtained as long as no scene change occurs. Note, however, that with a configuration where a scene change is detected, it is possible to suppress the disturbance in the display brightness, etc., which may occur upon a scene change.

### Embodiment 2

A display apparatus according to Embodiment 2 of the present invention and a method for controlling the same will now be described.

While Embodiment 1 is directed to an example where the target brightness is corrected, the present embodiment is directed an example where the characteristic value is corrected.

(General Configuration)

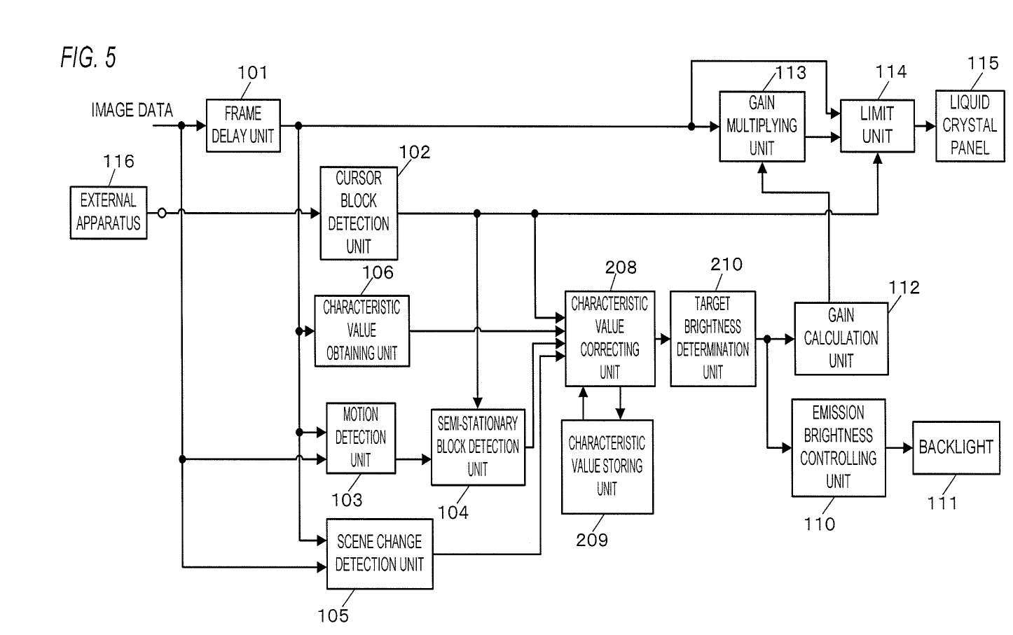

FIG. 5 is a block diagram showing an example of a functional configuration of the display apparatus according to the present embodiment.

Note that like functional units to those of Embodiment 1 will be denoted by like reference numerals, and will not be described below.

A characteristic value correcting unit 208 corrects the characteristic value obtained for the light source corresponding to the semi-stationary cursor block on the basis of the characteristic values obtained for the surrounding light sources (correction process). That is, the characteristic value correcting unit 208 corrects the characteristic value corresponding to the semi-stationary cursor block on the basis of the characteristic value corresponding to the surrounding divided areas. Herein, the characteristic value is a characteristic value representing the brightness of an image to be displayed in an area corresponding to the light source, as in Embodiment 1. Hereinbelow, the characteristic value before the correction process (the characteristic value obtained in the characteristic value obtaining unit 106) will be referred to as the “initial characteristic value”, and the characteristic value after the correction process will be referred to as the “final characteristic value”. In the present embodiment, the characteristic value correcting unit 208 corrects the initial characteristic value in the current frame (target frame) by referencing the final characteristic value in a past frame (the frame preceding the target frame). In the present embodiment, the final characteristic value corresponding to the semi-stationary cursor block is a value that has been corrected on the basis of the initial characteristic values obtained for light sources around the light source corresponding to the semi-stationary cursor block. The final characteristic values corresponding to the other divided areas are values that have been obtained by the characteristic value obtaining unit 106.

Then, the characteristic value correcting unit 208 outputs a plurality of final characteristic values corresponding to a plurality of divided areas (a plurality of light sources).

Note that the final characteristic value corresponding to the semi-stationary cursor block may be a value that has undergone the above correction process based on the initial characteristic values obtained for light sources around the light source corresponding to the semi-stationary cursor block, and another correction process of any type different from the above correction process. The final characteristic values corresponding to the other divided areas may be values that have undergone a correction process of any type.

A characteristic value storing unit 209 stores a plurality of final characteristic values corresponding to a plurality of divided areas. In the present embodiment, when the correction process is performed by the characteristic value correcting unit 208, the final characteristic values of the divided areas in a past frame (the frame preceding the target frame) are stored in the characteristic value storing unit 209. Then, the characteristic value storing unit 209 outputs the final characteristic values of the divided areas in the past frame to the characteristic value correcting unit 208, and obtains and stores the final characteristic values (the final characteristic values in the target frame) of the divided areas output from the characteristic value correcting unit 208.

With a target brightness determination unit 207 and the emission brightness controlling unit 110, for each light source, the emission brightness of the light source is controlled to a value based on the final characteristic value corresponding to the light source. That is, for each divided area, the emission brightness of the light source corresponding to the divided area is controlled to a value based on the final characteristic value corresponding to the divided area.

Specifically, for each of a plurality of light sources, the target brightness determination unit 207 determines the target brightness based on the final characteristic value corresponding to the light source, thus outputting information representing the target brightness of each light source.

The emission brightness controlling unit 110 performs the same process as that of Embodiment 1.

(Feature Value Correcting Unit 208)

The characteristic value correcting unit 208 will be described in detail.

The characteristic value correcting unit 208 obtains the initial characteristic value in the target frame from the characteristic value obtaining unit 106. The characteristic value correcting unit 208 obtains the final characteristic value in the frame preceding the target frame from the characteristic value storing unit 209. The characteristic value correcting unit 208 obtains the detection result of the cursor block detection unit 102, the detection result of the semi-stationary block detection unit 104, and the detection result of the scene change detection unit 105.

The characteristic value correcting unit 208 determines, as a semi-stationary cursor block, a divided area that has been detected as a cursor block and that has been detected as a semi-stationary block.

If a scene change is detected by the scene change detection unit 105, the characteristic value correcting unit 208 does not perform the correction process, but outputs, as the final characteristic value, the initial characteristic value of each divided area obtained from the characteristic value obtaining unit 106.

If no scene change is detected by the scene change detection unit 105, the characteristic value correcting unit 208 performs the following process.

That is, the characteristic value correcting unit 208 detects (selects) a similar light source from among a plurality of light sources located around the light source corresponding to the semi-stationary cursor block. That is, the characteristic value correcting unit 208 detects (selects) a similar area from among a plurality of areas (divided areas) located around the semi-stationary cursor block. In the present embodiment, detected as a similar area is a divided area for which an initial characteristic value is obtained that is most similar to the initial characteristic value which would be obtained for the semi-stationary cursor block if no cursor were displayed in the semi-stationary cursor block. Specifically, the final characteristic value in the frame preceding the target frame is referenced. Then, from among a plurality of divided areas located around the divided area corresponding to the semi-stationary cursor block, an area that satisfies Conditions 5 and 6 below is selected as the similar area.

(Condition 5) Is an area other than the cursor block.

(Condition 6) The difference in final characteristic value in a past frame from the semi-stationary cursor block is less than or equal to a threshold value.

If there are a plurality of divided areas that satisfy Conditions 5 and 6 above, from among the plurality of divided areas, an area having the smallest difference in final characteristic value is selected as the similar area.

Note that Conditions 5 and 6 above may be replaced by Conditions 7 and 8 below to detect a light source that satisfies Conditions 7 and 8 below as a similar light source.

(Condition 7) Corresponds to an area other than the cursor block.

(Condition 8) The difference in final characteristic value in a past frame from the light source corresponding to the semi-stationary cursor block is less than or equal to a threshold value.

Next, the characteristic value correcting unit 208 substitutes the initial characteristic value of the semi-stationary cursor block in the target frame, for the initial characteristic value of the selected similar area in the target frame, and outputs it as the final characteristic value.

For divided areas other than the semi-stationary cursor block, the characteristic value correcting unit 208 outputs the initial characteristic value of each divided area obtained from the characteristic value obtaining unit 106 as the final characteristic value. Therefore, where there is no similar area, the correction process is not performed, and the initial characteristic value of the divided area obtained from the characteristic value obtaining unit 106 is output as the final characteristic value.

As described above, according to the present embodiment, the initial characteristic value obtained for the light source corresponding to the semi-stationary cursor block is corrected on the basis of the initial characteristic value obtained for the surrounding light sources. Thus, it is possible to suppress changes in the display brightness due to superimposing display of the cursor in such a manner that changes in the display brightness due to image changes of the original image will not be suppressed.

Specifically, in the present embodiment, a similar area is detected when it is determined that the cursor is displayed in a divided area including no moving object therein. In other words, a similar area is detected if the cursor block is a semi-stationary cursor block that is detected as a semi-stationary block. Then, the initial characteristic value corresponding to the semi-stationary cursor block is substituted for the initial characteristic value corresponding to the similar area, and the emission brightness of the light source corresponding to the semi-stationary cursor block is control led to the same value as the emission brightness of the light source corresponding to the similar area.

Thus, where the cursor is displayed in a divided area including no moving object therein, it is possible to suppress the local change in the display brightness around the cursor (image quality deterioration). If the brightness value of the image data in an area around the cursor changes due to image changes not involving movements, it is possible to change the emission brightness of the light source corresponding to the semi-stationary cursor block in accordance with the change in the brightness value. As a result, where a cursor is displayed in a divided area including no moving object therein, even if the brightness value of the image data in an area around the cursor changes due to image changes not involving movements, it is possible to display the area around the cursor with an accurate display brightness.

Thus, it is possible to suppress changes in the display brightness due to superimposing display of the cursor in such a manner that changes in the display brightness due to image changes of the original image will not be suppressed.

Note that as with the method for correcting the target brightness described in Embodiment 1, any of various methods may be employed as the method for correcting the characteristic value in the present embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s).

This application claims the benefit of Japanese Patent Application No. 2013-125313, filed on Jun. 14, 2013, which is hereby incorporated by reference herein in its entirety.

What is claimed is:

1. A display apparatus comprising:
a light-emitting unit having a plurality of light sources of which emission brightness can be controlled individually;
a display unit configured to display an image on a screen by modulating light from the light-emitting unit;
a determination unit configured to determine, for each of the plurality of light sources, a target brightness based on a brightness of an image to be displayed in an area on the screen corresponding to the light source;
a first detection unit configured to detect, as a first block, an area in which a predetermined object is displayed, from among a plurality of areas corresponding to the plurality of light sources;
a second detection unit configured to detect, as a second block, an area in which no moving object is displayed, from among the plurality of areas;
a correction unit configured to correct a target brightness of a light source corresponding to a third block, which is an area which has been detected as a first block by the first detection unit and which has been detected as a second block by the second detection unit, on the basis of target brightnesses of surrounding light sources; and
a control unit configured to control, for each of the light sources, an emission brightness of the light source to the target brightness.

2. The display apparatus according to claim 1, wherein the correction unit corrects the target brightness of the light source corresponding to the third block, on the basis of the target brightness of a light source corresponding to a second block which has not been detected as a first block, from among a plurality of surrounding light sources.

3. The display apparatus according to claim 1, wherein the correction unit:
selects a light source which corresponds to an area other than the first block and for which a difference in target brightness in a past frame from the light source corresponding to the third block is less than or equal to a threshold value, from among a plurality of light sources located around the light source corresponding to the third block; and
brings the target brightness of the light source corresponding to the third block in a current frame closer to the target brightness of the selected light source in the current frame.

4. The display apparatus according to claim 3, wherein when there are a plurality of light sources, around the light source corresponding to the third block, which correspond to areas other than the first block and for which the difference in target brightness is less than or equal to the threshold value, the correction unit selects a light source for which the difference in target brightness is the smallest, from among the plurality of light sources.

5. The display apparatus according to claim 3, wherein the correction unit substitutes the target brightness of the light source corresponding to the third block in the current frame, with the target brightness of the selected light source in the current frame.

6. The display apparatus according to claim 3, wherein when there is no light source, around the light source corresponding to the third block, which corresponds to an area other than the first block and for which the difference in target brightness is less than or equal to the threshold value, the correction unit does not perform a process of correcting the target brightness of the light source corresponding to the third block on the basis of target brightnesses of surrounding light sources.

7. The display apparatus according to claim 3, wherein the past frame is a frame preceding the current frame.

8. The display apparatus according to claim 1, further comprising a motion detection unit configured to detect, for each of the plurality of light sources, a motion of an image in an area corresponding to the light source,
wherein the second detection unit detects, as the second block, an area corresponding to a light source of which surrounding light sources includes a predetermined number or more of light sources for which no motion of an image is detected by the motion detection unit.

9. The display apparatus according to claim 1, further comprising a motion detection unit configured to detect, for each of the plurality of light sources, a motion of an image in an area corresponding to the light source,
wherein the second detection unit detects, as the second block, an area corresponding to a light source for which it is determined by the motion detection unit that there is no motion of an image continuously over a plurality of frames.

10. The display apparatus according to claim 1, further comprising:
a motion detection unit configured to detect, for each of the plurality of light sources, a motion of an image in an area corresponding to the light source; and
a storage unit configured to store a detection result from the motion detection unit, wherein:
the second detection unit detects the second block on the basis of the detection result stored in the storage unit; and
the storage unit does not update the stored detection result for a light source corresponding to the first block.

11. The display apparatus according to claim 1, further comprising a scene change detection unit configured to detect a switching between scenes,
wherein when a switching between scenes has been detected by the scene change detection unit, the correction unit does not perform a process of correcting the target brightness of the light source corresponding to the third block on the basis of target brightnesses of surrounding light sources.

12. The display apparatus according to claim 1, wherein the predetermined object is an assistant object assisting a user operation.

13. The display apparatus according to claim 1, wherein the predetermined object is a cursor.

14. A display apparatus comprising:
a light-emitting unit having a plurality of light sources of which emission brightness can be controlled individually;
a display unit configured to display an image on a screen by modulating light from the light-emitting unit;
an obtaining unit configured to obtain, for each of the plurality of light sources, a characteristic value representing a brightness of an image to be displayed in an area on the screen corresponding to the light source;
a first detection unit configured to detect, as a first block, an area in which a predetermined object is displayed, from among a plurality of areas corresponding to the plurality of light sources;
a second detection unit configured to detect, as a second block, an area in which no moving object is displayed, from among the plurality of areas;
a correction unit configured to correct a characteristic value which has been obtained for a light source corresponding to a third block, which is an area which has been detected as a first block by the first detection unit and which has been detected as a second block by the second detection unit, on the basis of characteristic values which have been obtained for surrounding light sources; and
a control unit configured to control, for each of the light sources, an emission brightness of the light source to a value based on a characteristic value corresponding to the light source.

15. A method for controlling a display apparatus that includes:
a light-emitting unit having a plurality of light sources of which emission brightness can be controlled individually; and
a display unit configured to display an image on a screen by modulating light from the light-emitting unit,
the method comprising:
determining, for each of the plurality of light sources, a target brightness based on a brightness of an image to be displayed in an area on the screen corresponding to the light source;
detecting, as a first block, an area in which a predetermined object is displayed, from among a plurality of areas corresponding to the plurality of light sources;
detecting, as a second block, an area in which no moving object is displayed, from among the plurality of areas;
correcting a target brightness of a light source corresponding to a third block, which is an area which has been detected as a first block and which has been detected as a second block, on the basis of target brightnesses of surrounding light sources; and
controlling, for each of the light sources, an emission brightness of the light source to the target brightness.

16. A method for controlling a display apparatus that includes:
a light-emitting unit having a plurality of light sources of which emission brightness can be controlled individually; and
a display unit configured to display an image on a screen by modulating light from the light-emitting unit,
the method comprising:
obtaining, for each of the plurality of light sources, a characteristic value representing a brightness of an image to be displayed in an area on the screen corresponding to the light source;
detecting, as a first block, an area in which a predetermined object is displayed, from among a plurality of areas corresponding to the plurality of light sources;
detecting, as a second block, an area in which no moving object is displayed, from among the plurality of areas;
correcting a characteristic value which has been obtained for a light source corresponding to a third block, which is an area which has been detected as a first block and which has been detected as a second block, on the basis of characteristic values which have been obtained for surrounding light sources; and
controlling, for each of the light sources, an emission brightness of the light source to a value based on a characteristic value corresponding to the light source.
